(19) United States
(12) Patent Application Publication
(10) Pub. No.: US 2011/0017881 A1
(43) Pub. Date: Jan. 27, 2011

(54) Piece of Furniture Assembled in a Modular Way

(76) Inventor: Fritz Arendt, Dresden (DE)

Correspondence Address: GUDRUN E. HUCKETT DRAUDT, SCHUBERTSTR. 15A, WUPPERTAL, 42289, DE

(21) Appl. No.: 12/898,739

(22) Filed: Oct. 6, 2010

Related U.S. Application Data
(63) Continuation of application No. PCT/EP2009/002519, filed on Apr. 6, 2009.

(30) Foreign Application Priority Data
Apr. 6, 2008 (DE) 10 2008 017 607.9

(51) Int. Cl. F16M 11/04; F16L 3/08; F16B 2/02

(52) U.S. Cl. 248/74.1

(57) ABSTRACT

A modular piece of furniture has a base and a vertical cylindrical support column centrally and fixedly connected to the base. Clamp brackets are connected to the support column by a clamping action. Platforms are connected to the clamp brackets. Cable holding and guiding elements are connected by the clamp brackets to the support column. The center of gravity of the modular piece of furniture, when fully loaded with devices received on the platforms, is located within immediate vicinity of or in the area of the base.

### CROSS-REFERENCE TO RELATED APPLICATIONS

This application is a continuation application of international application PCT/EP2009/002519 having a filing date of 06 Apr. 2009, the contents of which are incorporated herein by reference in its entirety, and claims the benefit under 35 USC 119 of the filing date of foreign application DE 10 2008 017 607.9 filed in Germany on 06 Apr. 2008, the contents of which are incorporated herein by reference in its entirety.

### BACKGROUND OF THE INVENTION

The invention relates to a piece of furniture assembled in a modular way which is, in particular, intended as a workstation for information and data processing. It comprises individual modules that may be assembled or disassembled without tools and it therefore may be moved without difficulty. In addition, adaptation to the ergonomic requirements of the user and to various device configurations may be advantageously realized.

A movable computer and reading station is disclosed in DE 203 17 193 U1. This reading station is essentially comprised of a base on wheels to which a height-adjustable column is attached. A radially projecting swinging arm, which bears a shelf for receiving a computer, is arranged on the adjustable part of the column. The shelf is adjustable in terms of its distance and its tilt in relation to the column. Further shelves, for example, for deposition of a mouse, may be arranged in the described manner on the height-adjustable part of the column. The disclosed computer/reading stations exhibit a certain instability, in particular as a result of the asymmetrical arrangement and the division of the column, which is a prerequisite for its height adjustability; this instability is increased by the mobility of the station. Aside from structural strength and stability, means for guiding cables are lacking.

A computer stand according to DE 295 05 530 U1 follows the construction principles described above. Herein, the height-adjustable central column is implemented as a pneumatic spring on which reception shelves are arranged at various horizontal levels. The base connected with the column can be implemented to be either mobile or immobile.

U.S. Pat. No. 6,269,753 B1 also does not eliminate the criticized features of the prior art. Here, a computer desk is described for working in a standing, sitting, or reclining position; it also has a height-adjustable column. The base part is mobile and in addition implemented partly in a telescopic way.

Furthermore, a device for receiving a portable computer is known and disclosed in DE 10 2004 033 911 B1. This device comprises only a few parts detachably connected to each other, wherein the joints within the base part and the connections between the base part and the column as well as between the column and a supporting arm for a receiving shelf are plug-in connections with disengageable locking action. Here, versatility of design is lost in favor of dismantability. Previous statements about stability and the incorporation of supply cables apply as well.

It would therefore be desirable to provide a modularly constructed piece of furniture that is preferably usable as an IT (information technology) workstation and that remedies the disadvantages of the prior art, essentially the inadequate design-related structural strength and stability and the lack of a cable guide. In particular, the piece of furniture should be characterized by a high degree of flexibility with regard to adjustability and the size of the individual reception shelf and work plate, taking ergonomic considerations into account. In this connection, stability which meets the requirements for occupational and industrial safety must be ensured for all approved load situations. In addition, the piece of furniture must have an aesthetic design.

### SUMMARY OF THE INVENTION

In order to fulfill these goals, the object Of the present invention is to develop a piece of furniture of modular design that satisfies the aforementioned requirements. Furthermore, optionally constructive means are to be provided for guiding cables.

The modular piece of furniture according to the present invention comprises:
a base;
a vertical cylindrical support column centrally and fixedly connected to the base;
clamp brackets connected to the support column by a clamping action, respectively;
platforms connected to the clamp brackets and projecting radially away from the support column, wherein the platforms are selected from a work plate and a device platform;
cable holding and guiding elements connected by the clamp brackets to the support column;
wherein a center of gravity of the modular piece of furniture, when fully loaded with devices received on the platforms, is located within immediate vicinity of or in the area of the base.

The base comprises three points of contact forming an equilateral triangle, wherein a length of a triangle side of the equilateral triangle is a multiple of a height of the base.

The base may comprise means for weighing down the base wherein the means are integrated into the base.

The clamp brackets are identical.

The clamp brackets engage about the support column so as to be attached in a force-locked and detachable way to the support column at any height and any radial position of the support column.

The clamp brackets and platforms (shelves, work plates) are connected to each other by a detachable connection with at least two degrees of freedom.

The two degrees of freedom are selected from a longitudinal slidable movement, a rotary movement, and a pivot movement.

The cable holding and guiding element comprise a U-shaped cable conduit that extends spaced apart and parallel to the support column, wherein the cable conduit substantially extends continuously across the entire length of the support column.

Ancillary elements may be connected to the platforms.

The platforms (shelves, work plates) may vary in size, shape, material and design.

Thus, the solution to the object as stated above for a piece of furniture of the aforementioned kind, comprising a vertical support column mounted on a base part, is characterized by clamp brackets attached to the support column and carrying work plates, device platforms, and the like. The base contacts the floor via three points of contact and is implemented so as to be broadly cantilevered, but as flat as possible so as not to impair the user.

A cylindrical support column with a vertical orientation is arranged at the center of the base. The support column is implemented as a compact, undivided component without height adjustability.

The base and the support column are securely connected to each other, thereby forming a structural unit, and this ensures a particularly high level of structural strength and stability. Structural features and appropriate selection of materials ensure that the center of gravity of the entire piece of furniture according to the invention is located in immediate proximity of or in the area of the base when the piece of furniture is fully loaded with devices.

At least one, but advantageously several radially oriented platforms are mounted to the support column by means of clamping connections. The platforms serve various purposes and are therefore implemented as work plates, device platforms, cable holders, and the like. The clamping connections are implemented as clamp brackets. The latter engage about the support column so that a friction-locked but detachable securing action on the support column at a freely selectable height is enabled.

In addition, because of the cylindrical implementation of the support column, the clamping connections are also radially adjustable in any position. Suitable technical means must be selected for this purpose. Screw locks or toggle locks are advantageously available.

A platform is attached to each of the individual clamp brackets. A detachable type of attachment with at least two degrees of freedom is preferable. With regard to high flexibility, the platforms should be attached in a centric or eccentric arrangement to the clamp brackets in a manner so as to be longitudinally slidable and/or rotatable and/or pivotable.

Depending on the purpose, the platforms may have a variety of forms and embodiments. For example, a projecting rim may be expedient. In addition, it is possible to attach ancillary elements such as pull-out or swivel boxes or shelves. Cable holders or guiding elements are advantageously attached to the support column by means of the clamp brackets, and are advantageously implemented as a cable conduit extending continuously and parallel to the support column. The cable conduit can also be implemented separately if continuous design is not feasible. All important parts of the piece of furniture are made of wood, although this is not mandatory. The design can be purely practical or artistic; ergonomic considerations should be taken into account however.

In the following embodiment, the invention is explained with the help of drawings illustrating a tree-like piece of furniture to be used as an IT workstation.

### BRIEF DESCRIPTION OF THE DRAWINGS

FIG. 1 is a representation of a tree-like piece of furniture according to the invention.

FIG. 2 shows a side view of base and support column.

FIG. 3 shows a section view of base and support column.

FIG. 4 shows a top view of the base.

FIG. 5 shows a side view of a clamping bracket and an attached platform.

FIG. 6 shows an end view of the arrangement of FIG. 5.

FIG. 7 shows a top view of the arrangement of FIG. 5.

FIG. 8 shows a perspective view of the arrangement of FIG. 5.

### DESCRIPRION OF PREFERRED EMBODIMENTS

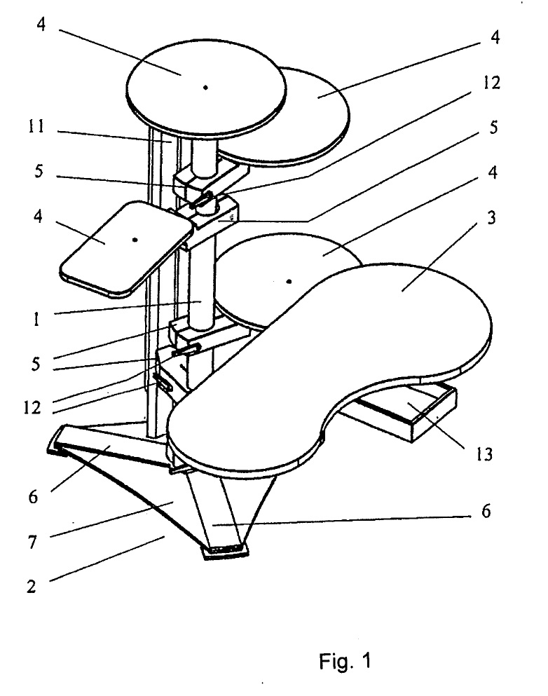

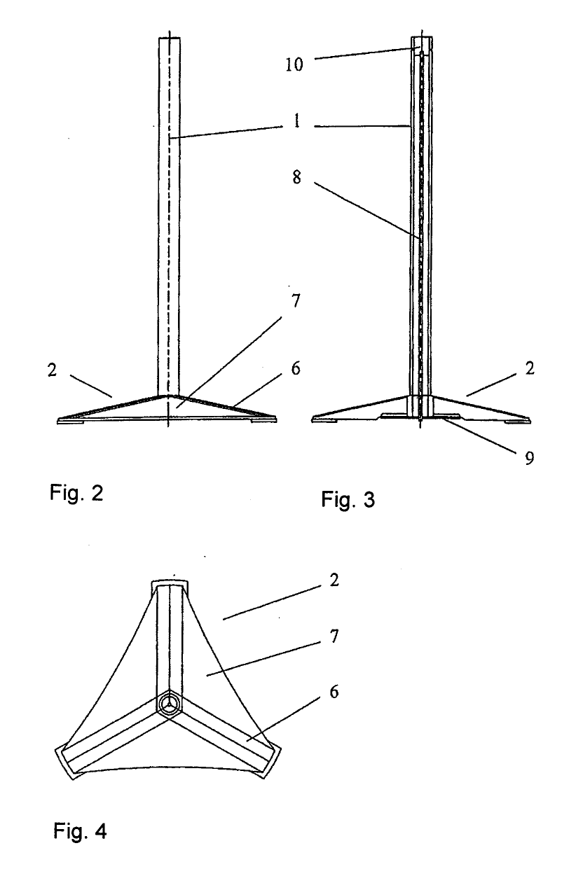

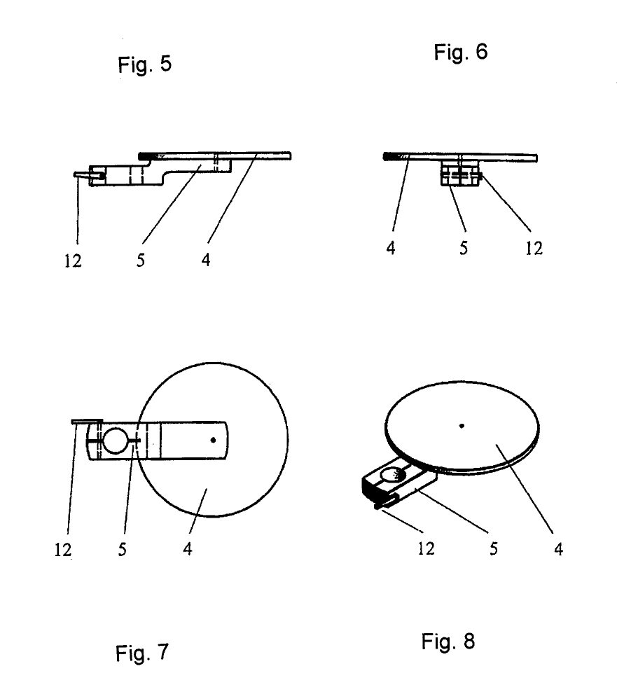

According to FIG. 1, the piece of furniture as an IT workstation essentially comprises a base 2, a cylindrical support column 1, a work plate 3, several device platforms 4, a cable conduit 11, and clamp brackets 5 to attach the mentioned individual parts 3, 4, 11 to the support column 1.

In the illustrated embodiment, the base 2 is comprised of three support arms 6 that are secured by means of stabilization plates 7. A vertical support column 1 is fixedly connected to the center of the base 2. To ensure high stability of the connection, the base 2 and the support column 1 are clamped against each other. For this purpose, clamping screw 8 is inserted into the support column 1, a large disk 9 is arranged underneath the base 2, and a cover element 10 is positioned on or inserted into the support column 1. By tightening the cover element 10 and the disk 9 relative to one another, base 2 and support column 1 are fixedly pressed against one another.

A compact component is thus formed that is able to conduct the forces caused by the attachments connected to the support column 1 into the installation site with adequate safety, wherein the triangular shape of the base 2 already provides a high-level of stability. The described manner of connection is to be viewed as one possible solution.

With regard to material, it is suggested that the base 2 be embodied of wood and that, for producing the support column 1, wood should also be used. A stainless steel pipe can be used for the support column 1 in a more refined embodiment. Other materials can also be used as long as the criteria for high stability and strength are met.

In any case, however, it must be ensured that the selection of components and materials for the base 2 be such that the center of gravity of the entire piece of furniture as IT workstation is in the area of the base 2 or is at least in its immediate proximity when the piece of furniture is fully loaded or equipped with devices.

The platforms and the cable conduit 11 are attached to the support column 1 and project radially away from the support column 1. The clamp brackets 5 that engage about the support column 1 serve as the means of attachment and are implemented such that they are friction-locked but detachably connected to the support column 1 at any freely selectable height and radial position. Suitable technical means for this purpose are slotted clamp brackets 5 in the area of the support column 1 with use of a clamping element 12, preferably implemented as a screw lock or toggle lock.

The platforms, namely the device platforms 4 and the work plate 3, are arranged on the clamp brackets 5. In addition, the cable conduit 11 is also attached by the clamp brackets 5 in a parallel orientation relative to the support column 1.

For this purpose, either fixed connections or pivotable and/or rotary arrangements should be selected, using appropriate technical means, and in particular mounted in a centric or eccentric manner.

The possibility of mounting ancillary elements to the device platforms 4 and/or the work plate 3 has been mentioned before in the present description. For example, a drawer 13 is arranged underneath the work plate 3. The work plate 3, the device platforms 4 as well as the cable conduit 11 and the clamp brackets 5 are realizable in a variety of forms, materials, and designs. Reference is being had to the explanations in the description.

While specific embodiments of the invention have been shown and described in detail to illustrate the inventive principles, it will be understood that the invention may be embodied otherwise without departing from such principles.

What is claimed is:

1. A modular piece of furniture comprising:
a base;
a vertical cylindrical column centrally and fixedly connected to the base;
clamp brackets connected to the support column by a clamping action, respectively;
platforms connected to the clamp brackets and projecting radially away from the support column, wherein the platforms are selected from a work plate and a device platform;
cable holding and guiding elements connected by the clamp brackets to the support column;
wherein a center of gravity of the modular piece of furniture, when fully loaded with devices received on the platforms, is located within immediate vicinity of or in the area of the base.

2. The modular piece of furniture according to claim 1, wherein the base comprises three points of contact forming an equilateral triangle, wherein a length of a triangle side of the equilateral triangle is a multiple of a height of the base.

3. The modular piece of furniture according to claim 1, comprising means for weighing down the base wherein said means are integrated into the base.

4. The modular piece of furniture according to claim 1, wherein the clamp brackets are identical.

5. The modular piece of furniture according to claim 1, wherein the clamp brackets engage about the support column so as to be attached force-locked and detachable to the support column at any height and any radial position of the support column.

6. The modular piece of furniture according to claim 1, wherein the clamp brackets and platforms are connected by a detachable connection with at least two degrees of freedom.

7. The modular piece of furniture according to claim 6, wherein the two degrees of freedom are selected from a longitudinal sliding movement, a rotary movement, and a pivot movement.

8. The modular piece of furniture according to claim 1, wherein the cable holding and guiding elements comprise a U-shaped cable conduit that extends spaced apart and parallel to the support column, wherein the cable conduit substantially extends continuously across the entire length of the support column.

9. The modular piece of furniture according to claim 1, comprising ancillary elements connected to the platforms.

10. The modular piece of furniture according to claim 1, wherein the platforms vary in size, shape, material and design.
